(19) United States
(12) Patent Application Publication
(10) Pub. No.: US 2015/0061375 A1
(43) Pub. Date: Mar. 5, 2015

(54) ENERGY HARVESTING SYSTEM FOR AN AIRCRAFT

(71) Applicant: GOODRICH CORPORATION, Charlotte, NC (US)

(72) Inventors: Andre Hessling von Heimendahl, Koblenz (DE); Benjamin Elmer Bishop, JR., South Glastonbury, CT (US)

(73) Assignee: GOODRICH CORPORATION, Charlotte, NC (US)

(21) Appl. No.: 14/011,035

(22) Filed: Aug. 27, 2013

(51) Int. Cl. B64D 41/00; H02N 2/18; B60L 11/18; H01M 10/46

(52) U.S. Cl. CPC B64D 41/007; H01M 10/46; B64D 41/00; H02N 2/18; B60L 11/1809
USPC 307/9.1; 310/339

(57) ABSTRACT

An energy harvesting system for an aircraft includes an energy storage device, and an energy harvesting member electrically connected to the energy storage device and mechanically linked to the aircraft. The energy harvesting member is configured and disposed to generate an electrical energy output in response to one of a change in altitude of, or turbulence on, the aircraft.

### BACKGROUND OF THE INVENTION

Exemplary embodiments pertain to the art of motor vehicles and, more particularly, to an energy harvesting system for a motor vehicle.

Motor vehicles including land vehicles, water vehicles, and air vehicles include multiple electrical loads that are often powered by a battery. Oftentimes, the electrical loads are connected to the battery through long runs of electrical conductors or wires. As motor vehicles grow in complexity, the use of electrical components and, by extension, the need for more electrical conductors and connectors increases. The number of electrical conductors and connectors added to a motor vehicle represents a significant weight load that may impact performance. For example, the weight associated with the electrical conductors may have a negative impact on gas mileage for motor vehicles, or load maximums for air based vehicles. Also, the long runs of electrical conductors are exposed to harsh environments, including vibration, that could create open circuits that are hard to locate and repair.

### BRIEF DESCRIPTION OF THE INVENTION

Disclosed is an energy harvesting system for an aircraft including an energy storage device, and an energy harvesting member electrically connected to the energy storage device and mechanically linked to the aircraft. The energy harvesting member is configured and disposed to generate an electrical energy output in response to one of a change in altitude of, or turbulence on, the aircraft.

Also disclosed is an aircraft including a body having an exterior surface and one or more interior surfaces, an energy storage device arranged in the body, and an energy harvesting member electrically connected to the energy storage device and mechanically linked to the body. The energy harvesting member is configured and disposed to generate an electrical energy output in response to one of a change in altitude of, or turbulence on, the body of the aircraft.

Still further disclosed is a method of harvesting electrical energy in an aircraft. The method includes exposing an energy harvesting member mounted to a surface of the aircraft to one of a change in altitude or turbulence, generating an electrical energy in the energy harvesting member in response to the one of the change in altitude or turbulence, passing the electrical energy from the energy harvesting member to an electrical storage device, and storing the electrical energy in the electrical storage device.

### BRIEF DESCRIPTION OF THE DRAWINGS

The following descriptions should not be considered limiting in any way. With reference to the accompanying drawings, like elements are numbered alike:

FIG. 1 is a perspective view of an aircraft including an energy harvesting system, in accordance with an exemplary embodiment;

FIG. 2 is a schematic view of the energy harvesting system of FIG. 1;

FIG. 3 is a schematic view of an energy harvesting system, in accordance with another aspect of an exemplary embodiment; and

FIG. 4 is a schematic view of an energy harvesting system, in accordance with yet another aspect of the exemplary embodiment.

### DETAILED DESCRIPTION OF THE INVENTION

A detailed description of one or more embodiments of the disclosed apparatus and method are presented herein by way of exemplification and not limitation with reference to the Figures.

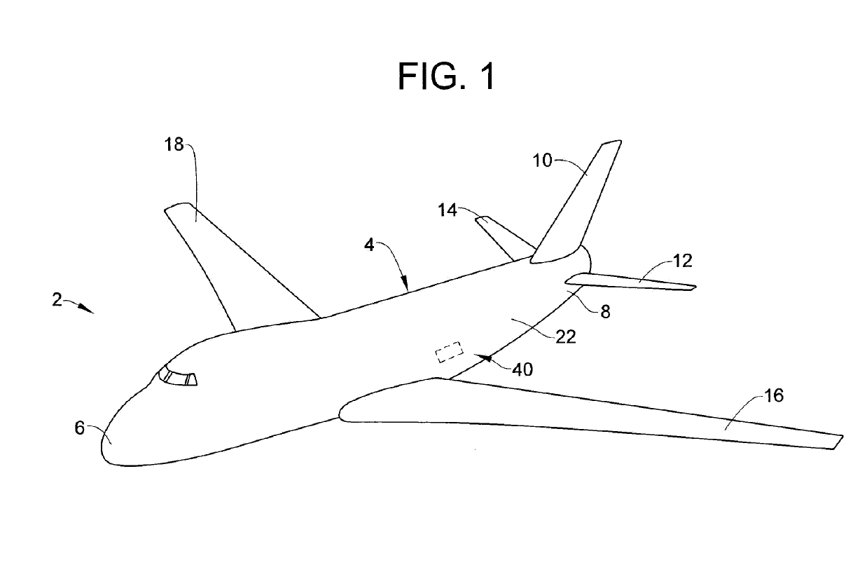

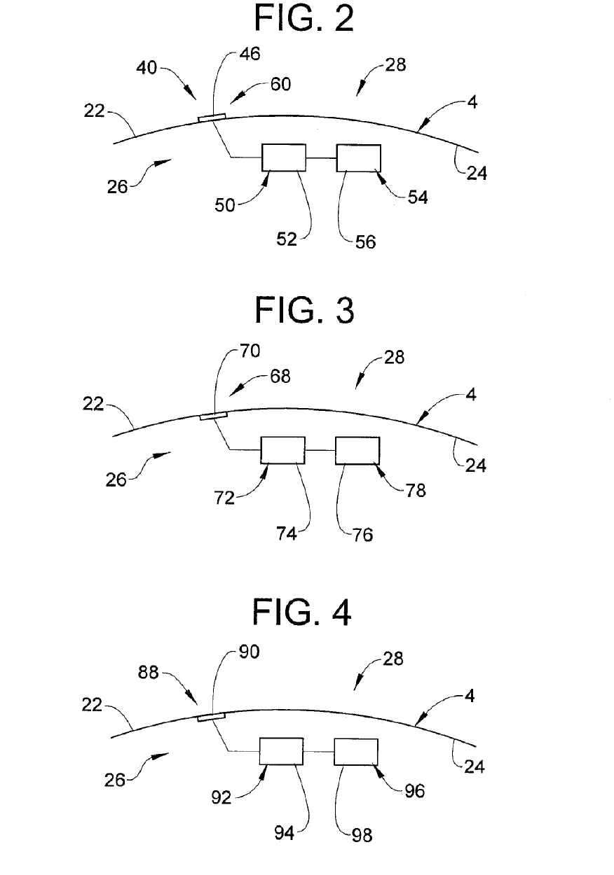

An aircraft, in accordance with an exemplary embodiment, is indicated generally at 2, in FIG. 1. Aircraft 2 includes a body 4 having a forward or nose portion 6 and an aft or tail portion 8. Tail portion 8 includes a vertical stabilizer 10, a first horizontal stabilizer 12, and a second horizontal stabilizer 14. Aircraft 2 also includes a first wing 16 extending from a port side (not separately labeled) of body 4 and a second wing 18 extending from a starboard side (also not separately labeled) of body 4. Body 4 includes an exterior or lower pressure surface 22 and an interior surface 24 (FIG. 2). Interior surface 24 defines an area of high or steady pressure 26 and exterior surface 22 defines an area of lower or fluctuating pressure 28.

In accordance with an exemplary embodiment, aircraft 2 includes an energy harvesting member 40 mounted to body 4. In the exemplary aspect shown, energy harvesting member 40 may take the form of a pressure transducer 46 mounted to exterior surface 22. Pressure transducer 46 is electrically coupled to an energy storage device 50 which may take the form of an ultracapacitor 52. Energy storage device 50 may be electrically coupled to an electrical load 54 which may take the form of a light 56, such as an LED. Of course it should be understood that one or more electrical control devices, such as a switch (not shown), may be electrically connected between energy harvesting member 40 and electrical storage device 50; and between electrical storage device 50 and electrical load 54.

In accordance with an exemplary embodiment, aircraft 2 experiences variations in pressure between high pressure zone 26 and low pressure zone 28 during various points of flight. Pressure changes occur during changes in altitude both on ascent and decent, as well as during periods of turbulence. The pressure changes lead to pressure fluctuations that create a zone of fluctuating pressure 60 about pressure transducer 46. The pressure fluctuations act upon pressure transducer 46 resulting in generation of an electrical current that is passed to energy storage device 50. The energy may be used to power light 56. In this manner, power may be provided for an electrical load without the need for long runs of conductors that increase complexity, manufacturing costs, and an overall weight of the aircraft. The number of energy harvesting devices may vary and can be located on any surface of body 4.

Reference will now be made to FIG. 3 in describing an energy harvesting member 68, in accordance with another aspect of the exemplary embodiment. Energy harvesting member 68 may take the form of a micro-turbine 70 provided in body 4 between exterior surface 22 and interior surface 24. Micro-turbine 70 responds to flows of air currents by creating electrical energy. Micro-turbine 70 is operatively connected to an energy storage device 72 which may take the form of a battery 74. Energy storage device 72 is electrically coupled to an electrical load 76 that may be a speaker or a Wi-Fi connection 78.

During flight, and in particular during altitude changes, air is expressed from high pressure zone 26 to low pressure zone 28. In accordance with the exemplary embodiment, at least a portion of the air is passed through one or more micro-turbines 70 to generate electrical energy for operating electrical load 76. In this manner, power may be provided for an electrical load without the need for long runs of conductors that increase complexity, manufacturing costs and an overall weight of the aircraft. The number of energy harvesting devices may vary and can be located on any surface of body 4.

Reference will now be made to FIG. 4 in describing an energy harvesting member 88, in accordance with another aspect of the exemplary embodiment. Energy harvesting member 88 takes the form of a piezo-electric element 90 that is mounted to interior surface 24. Of course it should be understood that piezo-electric element 90 may also be mounted to exterior surface 22. Piezo-electric element 90 is electrically connected to an energy storage device 92 which may take the form of a coiled spring and/or a flywheel 94. Energy storage device 92 is electrically connected to an electrical load 96 that may take the form of a sensor 98.

During flight, changes in altitude of and/or turbulence on, an aircraft 2 may result in dimensional changes to exterior surface 22 and/or interior surface 24 or other parts of body 4. The dimensional changes are realized by piezo-electric element 90. In response to the dimensional changes, piezo-electric element 90 generates a flow of electrical energy that is passed to energy storage device 92 and used to power electrical load 96. In this manner, power may be provided for an electrical load without the need for long runs of conductors that increase complexity, manufacturing costs, and an overall weight of the aircraft. The number of energy harvesting devices may vary and can be located on any surface of body 4.

At this point it should be understood that the exemplary embodiments describe a system for harvesting electrical energy from an aircraft resulting from changes in altitude and/or turbulence. Harvested electrical energy is passed to a local energy storage device and used to power electrical loads. In this manner, long runs of electrical cables that carry electrical energy from a central electrical source to loads may be reduced. The reduction in cabling leads to increased operational capacity and efficiencies of the aircraft. It should also be understood that the number and type of energy harvesting members may vary. Also, an aircraft may include various types of energy harvesting members. In addition, the number and type of electrical storage devices and electrical loads may vary, and some loads or storage devices may be located in low pressure zone 28 attached to exterior surface 22.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An energy harvesting system for an aircraft comprising:
an energy storage device; and
an energy harvesting member electrically connected to the energy storage device and mechanically linked to the aircraft, the energy harvesting member being configured and disposed to generate an electrical energy output in response to one of a change in altitude of and turbulence on the aircraft.

2. The energy harvesting system according to claim 1, wherein the energy harvesting member comprises a pressure transducer mounted to one of the exterior surface and an interior surface of the aircraft, the pressure transducer being configured and disposed to generate an electrical energy in response to pressure fluctuations on the exterior surface created by the one of the change in altitude and turbulence.

3. The energy harvesting system according to claim 1, wherein the energy harvesting member comprises a micro-turbine configured and disposed to generate an electrical energy in response to air passing between an interior surface and an exterior surface of the aircraft in response to the one of the change in altitude and turbulence.

4. The energy harvesting system according to claim 1, wherein the energy harvesting member comprises a piezo-electric element mounted to one of the exterior surface and an interior surface of the aircraft, the piezo-electric element being configured and disposed to generate an electrical energy in response to dimensional changes in the one of the exterior surface and the interior surface in response to the one of the change in altitude and turbulence.

5. The energy harvesting system according to claim 1, wherein the energy storage device comprises one of an ultracapacitor, a battery, a coiled spring, and a flywheel.

6. The energy harvesting system according to claim 1, further comprising: an electrical load operatively connected to the energy storage device.

7. A method of harvesting electrical energy in an aircraft comprising:
exposing an energy harvesting member mounted to a surface of the aircraft to one of a change in altitude and turbulence;
generating an electrical energy in the energy harvesting member in response to the one of the change in altitude and turbulence;
passing the electrical energy from the energy harvesting member to an electrical storage device; and
storing the electrical energy in the electrical storage device.

8. The method of claim 7, wherein exposing the energy harvesting member to environmental changes includes exposing the energy harvesting member to pressure changes resulting from the one of the change in altitude and turbulence.

9. The method of claim 7, wherein exposing the energy harvesting member to environmental changes includes exposing the energy harvesting member to dimensional changes of the surface resulting from the one of the change in altitude and turbulence.

10. The method of claim 7, wherein exposing the energy harvesting member to environmental changes comprises driving a micro-turbine with air passing from one portion of the aircraft to another portion of the aircraft or to the exterior of the aircraft resulting from the one of the change in altitude and turbulence.

11. The method of claim 7, wherein passing the electrical energy to an energy storage device comprises passing the electrical energy to one of an ultra capacitor, a battery, a spring and a flywheel.

12. The method of claim 7, further comprising: passing the electrical energy to an electrical load.
